(19) United States
(12) Patent Application Publication
(10) Pub. No.: US 2022/0019920 A1
(43) Pub. Date: Jan. 20, 2022

(54) EVIDENCE DECAY IN PROBABILISTIC TREES VIA PSEUDO VIRTUAL EVIDENCE

(71) Applicant: Raytheon Company, Waltham, MA (US)

(72) Inventors: Robert J. Cole, Pa Furnace, PA (US); David J. Wisniewski, Pa Furnace, PA (US); Ryan M. Kaulakis, Bellefonte, PA (US); Paul C. Hershey, Ashburn, VA (US)

(21) Appl. No.: 16/930,998

(22) Filed: Jul. 16, 2020

(51) Int. Cl. G06N 7/00; G06N 5/04; G06K 9/62

(52) U.S. Cl. CPC G06N 7/005; G06K 9/6282; G06N 5/04

(57) ABSTRACT

Evidence decay in PGMs is achieved using virtual evidence nodes that create and send lambda messages that when combined with the other evidence force specified beliefs onto the decaying evidence nodes. The virtual evidence nodes compute a step along a path from the decaying node's current belief to a target belief to determine the specified belief. Belief propagation is executed to process the pi and lambda messages to update the current beliefs for all nodes. Observation evidence is removed from the model. For each decaying node, belief propagation is executed absent the evidence of that node to generate an updated target belief. Following an observation, the node's belief will decay in a smooth, continuous manner.

### BACKGROUND OF THE INVENTION

### Field of the Invention

This invention relates to probabilistic graphical models (PGMs) and more particularly to evidence decay in probabilistic trees via pseudo virtual evidence.

### Description of the Related Art

A probabilistic graphical model (PGM) is a data structure representing the conditional dependence structure between a set of random variables. As such, it is a compact representation of the joint distribution between the variables.

As a concrete example of a PGM, consider a simple probabilistic graph 100 shown in FIGS. 1 and 2a-2b. In this horticulture model, node A represents a type of flower (iris), node B a sepal width and Node C a petal width. Each node or random variable is represented by a belief vector BEL(V) 200 for variable “V” having n possible values of which one and only one is in fact True and the remaining are False. The belief vector, which is a posterior distribution for the node, includes a probability for each value, which sum to one. The PGM will accept an observation of a certain value or “state” of the random variable and set the probability for that value to 1, and the remaining values to 0. The PGM construct does not allow for an observation of an uncertain value or “state” in which non zero probabilities would be assigned for multiple values.

Each random variable is discrete with variable Iris having three possible values corresponding to a species of Iris. The other two variables have two values each. Sepal_width has values LT_4 and GTE_4. These correspond to sepal widths less than 4.0 centimeters and sepal widths greater than or equal to 4.0 centimeters, respectively. Petal_width has values LT_1P5 and GTE_1P5. These correspond to petal widths less than 1.5 cm and petal widths greater than or equal to 1.5 cm, respectively.

The conditional dependence between these variables is represented by the tree structure of the model in which Iris is a parent node and the two width nodes are children. This encodes the fact that the probability of a width variable having a certain value is determined by the species of the parent variable. These probabilities are given in conditional probability tables (CPTs) 202, which are shown in FIG. 2a. For example, if the iris species is Setosa, than the probability of sepal width being less than 4 cm is 0.92. Regarding the sepal width variable, the belief vector, BEL, contains two elements corresponding to the probabilities of the two possible values of width. In this example, the belief vector is <0.973, 0.267>. As probabilities over a set of possible values, belief vectors must always sum to 1.

Belief vectors 200 for a node are computed using a process called inference. A standard method of inference in PGMs is belief propagation (BP), which is described below. In FIG. 2a, belief vectors 200 are shown inside each node.

The PGM is represented by a probabilistic trees structure including parent and child nodes, some of which represent unobservable (query) variables and others of which represent observable (evidence) variables. Evidence nodes correspond to variables whose values can be directly measured. In the example above, the two width nodes are evidence nodes. Query nodes correspond to variables whose values cannot be directly measured or observed. In this example, the Iris node is a query node since species is not something that can be directly measured, at least in an automated manner. The usefulness of a PGM lies in the process of using measurements regarding observable evidence nodes to update the belief regarding non-observable query nodes. For example, an automated system measuring sepal width and petal width could be used to compute the probability (i.e. belief) that a given example of Iris is a particular species. This is accomplished by setting a given evidence value in the model and subsequently performing inference. For example, suppose a flower instance was measured (observed) to have a petal width of 0.9 cm. In this case, evidence is set corresponding to Petal_Width=LT_1P5. The probability of LT_1P5=1 and the probability of GTE_1P5=0. The resulting belief vectors 204 are shown in FIG. 2b. Note that belief vectors for both the Iris node and the Sepal_Width node have been updated as a result of inference being performed after evidence was applied.

Belief propagation (BP) is a method for performing inference in a probabilistic graphical model. In other words, it is a method for computing node beliefs, either when a model is first instantiated or when something changes in the model such as evidence being applied or removed. BP was described by Judea Pearl “Probabilistic Reasoning In Intelligent Systems”, Morgan Kaufmann Publishers, 1988 and still remains a standard approach for performing inference in PGMs. For PGMs in tree or polytree topologies, it provides exact belief values whereas for more general PGM topologies, it only provides approximate results.

BP is based on a message passing process in which each node performs local computations and then constructs messages that are sent to neighboring nodes. Each node's local computations take into account the messages it has received from neighbors. In this manner, the effect of information stored at one node propagates to the rest of the model. For a tree topology 300, like that of FIG. 3, the inference process at a high level involves two steps:

1. Starting at leaf nodes, lambda messages 302 are passed upward to parent nodes. Each node waits until it has received messages from all of its children before composing its own lambda message to send to its parent. This step is complete when the root node has received messages from each child.

2. Starting at the root node, pi messages 304 are sent downward to child nodes. Each node receiving a pi message from a parent then composes a new pi message to send to each of its children. This step terminates when each leaf node has received a pi message from its parent.

For example, leaf nodes Y and Z pass lambda messages 302 to parent node X, which then computes its own lambda message. Leaf nodes V, X and W then compose and pass lambda messages to parent and root node U. Root node U passes pi messages 304 down to child nodes V, X and W and node X in turn sends pi messages to child nodes Y and Z.

### Pi Messages

Pi messages 304 are vectors sent from a node to each child node that represent the probability of the sending node, given the evidence contained in the sub-network of the model consisting of the sending node and above. For example, node U's pi message to child node X is denoted π_{X}(u) and is defined as:

π_{X}(u)=P(u|e_{X}⁺)

Here, e_{X}⁺ represents the evidence in the model above node X and thus includes any evidence applied to nodes U, V or W. The phrase above node X means all nodes that are not in a sub-network in which X is the root node. The pi message is a vector of probabilities, one for each value of u.

### Lambda Messages

Lambda messages 302 are vectors sent from a node to the node's parent node that represent the probability of the evidence in the model in a sub-network below the parent, given the parent value. For example, node X's lambda message to parent node U is denoted λ_{X}(u) and is defined as:

λ_{X}(u)=P(e_{X}⁻|u)

Here, e_{X}⁻ represents the evidence in the model below node U and thus includes any evidence applied to a sub-network of nodes X, Y or Z. The lambda message is a vector of probabilities, one for each value of u.

### Belief Computation

A node computes its own belief vector once it has received all expected pi and lambda messages. It does this by computing a pi value and a lambda value and then using these to compute belief.

The pi value represents the probability of a node's value given all evidence in the model above the node. For example, node X's pi value is denoted π(x) and is defined as:

π(x)=P(x|e_{X}⁺)

This value is computed using the pi message from the parent and the CPT values:

$$π ( x ) = {\sum }_{u} P ( x \vert u ) {π}_{X} ( u )$$

Note that P(x|u) is obtained from node X's CPT.

The lambda value represents the probability of the evidence below the node, given a particular node value. For example, node X's lambda value is denoted λ(x) and is defined as:

λ(\dot{x})=P(e_{X}⁻|x)

This value is computed using the lambda messages from the child nodes:

λ(x)=λ_{Y}(x)λ_{Z}(x)

Having computed the pi and lambda values, a node can then update its belief as follows:

BEL(x)=αλ(x)π(x)

Where α is a normalizing constant.

Certain evidence nodes may be both observable and have one or more child evidence nodes. Belief computation accounts for both observations of the random variable and evidence provided by the children.

PGMs are used to intelligence, surveillance and reconnaissance (ISR) systems and other systems, which often face limited collection (observation) opportunities. In these systems, evidence collected in the past, such as the fact of a ship being docked at a particular port, represents knowledge that comes under greater and greater doubt as time passes and the state of the object under surveillance has more and more opportunity to change. If the system is unable to update knowledge via re-observation, then the system is forced to somehow represent increasing doubt in the ISR models. This process of doubt increase is referred to here as “evidence decay”.

The present state-of-art for handling evidence decay in PGMs is the timer method. Under the timer method, a timer is started when an observation is made and evidence resulting from the observation is set in a model. Then, when the timer expires, the observations are removed from the relevant variables. The timer is set to a variable length of time representing the maximum duration over which the results of a particular observation are trustworthy.

As an illustration of the timer method, consider a simple probabilistic graph such as model 100 shown in FIG. 1 in which parent (query) Node A represents a surveillance a 4-dimensional target variable that is unobserved and child (evidence) Nodes B and C represent 3-dimensional (x,y,z) observable evidence. Suppose the x value of B is observed at time 10 and the y value of C is observed at time 30. Further, assume that B's value is removed after 30 time steps and C's value is removed after 60 time steps (i.e., timer method with durations of 30 and 60, respectively). The resulting belief vectors 400, 402 and 404 for Nodes A, B and C over time might look like that shown in FIG. 4. Node B belief vector has a value of say (0.48, 0.27, 0.25) prior to the observation and a value of (1, 0, 0) after the observation. Node C belief vector has a value of (0.25, 0.3, 0.45) prior to its observation and a value of (0, 1, 0) after the observation. Target belief 400 changes discontinuously at times 10 and 30 when the knowledge changes discontinuously with the observation of variables B and C, respectively. Target belief 400 also changes discontinuously at time 40 when variable B's evidence is removed and again at time 90 when variable C's evidence is removed at which point the belief vectors 402 and 404 return to the beliefs set by all evidence in the model.

PGMs as constituted only allow for an observation of a particular value or state of a random variable, which then sets that value to a probability of one and the remaining values to a probability of zero. The observation may either be set in the model or removed. There is no mechanism to “decay” the observation over a period of time to provide a smooth, continuous transition of the node belief from the certainty of the observation to what would be dictated by the model absent the observation, it is all or nothing. Under the timer method this produces beliefs for observed nodes that are artificially inflated over a period of time and a discontinuity in the belief of the observed nodes and nodes to which it provides evidence.

### SUMMARY OF THE INVENTION

The following is a summary of the invention in order to provide a basic understanding of some aspects of the invention. This summary is not intended to identify key or critical elements of the invention or to delineate the scope of the invention. Its sole purpose is to present some concepts of the invention in a simplified form as a prelude to the more detailed description and the defining claims that are presented later.

The present invention provides for the decay of evidence in PGMs in which evidence node beliefs, following an observation of the node's random variable, decay in a smooth, continuous manner over a decay period to a target belief in a manner that is determined and updated via pseudo virtual evidence.

This is accomplished within the PGM construct by creating virtual evidence nodes that create and send lambda messages that when combined with the other evidence force a specified belief onto the parent (decaying) evidence node. Observations are treated as before to assign a deterministic state to random variable of a node, that state being assigned a probability of one and the remaining states a probability of zero. Unlike the timer method, the observations are not held over the decay period. Following an observation, a target belief is computed by executing belief propagation on the model absent evidence of a given decay node. The virtual evidence node computes a step along a path from the current belief (initially the deterministic state) to the target belief to determine the specified belief BEL*. The virtual node uses the pi value π(x) for the decaying node x to determine the lambda message required to force the specified belief BEL* onto the parent bide. The lambda message constitutes “pseudo” virtual evidence derived from the model; it does not represent actual observed evidence. After each application of evidence, belief propagation is executed to process the lambda and pi messages to update node beliefs, target beliefs for decaying nodes are updated and observation evidence is removed. As time progresses over the decay period, the observation and the initial deterministic state is de-emphasized relative to the belief assigned to a node by the model absent the observation providing for a smooth, continues transition at the end of the decay period.

These and other features and advantages of the invention will be apparent to those skilled in the art from the following detailed description of preferred embodiments, taken together with the accompanying drawings, in which:

### BRIEF DESCRIPTION OF THE DRAWINGS

FIG. 1, as described above, is a tree structure for a simple probabilistic graphical model (PGM);

FIGS. 2A and 2B, as described above, are examples of a PGM for a horticulture model before and after applying evidence of an observation of one of the random variables;

FIG. 3, as described above, illustrates a probabilistic tree in which belief propagation (BP) passes lambda messages upward to parent nodes and pi messages downward to child nodes for performing inference in a PGM to compute node beliefs;

FIG. 4, as described above, is a plot of belief components for the model nodes illustrating the timer method for handling evidence decay;

FIG. 5 is a tree structure for a PGM including virtual evidence nodes to pass lambda messages (pseudo virtual evidence) from the virtual evidence nodes to the parent nodes to force a specified belief distribution on the evidence nodes in accordance with the present invention;

FIG. 6 is a plot of belief components for the model nodes illustrating evidence decay via pseudo virtual evidence;

FIG. 7 is a plot illustrating stepping a long a path from a current belief to a target belief for a three-dimensional evidence random variable;

FIG. 8 is a flow diagram for implementing evidence decay in a PGM via pseudo virtual evidence;

FIGS. 9A and 9B are a flow diagram of an embodiment for computing a lambda message to force a specified belief onto a node and a plot of different scale factors for the forcing function;

FIG. 10 is a diagram illustrating an embodiment of the update target belief algorithm;

FIGS. 11A-11E are illustrations of a PGM using the “decay evidence” approach to model whether a ship is preparing for departure; and

FIG. 12 is a block diagram of a machine able to read instructions from a machine-readable medium and perform any one or more of the methodologies discussed herein.

### DETAILED DESCRIPTION OF THE INVENTION

For intelligence, surveillance and reconnaissance (ISR) systems and other systems that often face limited collection (observation) opportunities, a better solution for “decay evidence” in PGMs than the timer method in which observations are artificially maintained over a decay period causing node beliefs to exhibit a sharp discontinuity at the end of the decay period is desired. Following an observation of a node's random variable, the node belief should decay in a smooth, continuous manner over a decay period from the deterministic state to a target belief the node has, or will have, when the evidence in question is completely removed from the model at the end of the decay period. This solution must reside within the PGM construct and belief propagation.

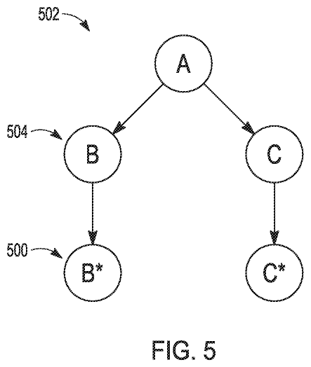

The “decay evidence” approach leverages the concept of “virtual evidence” as described by Pearl. Under this approach, a virtual evidence node 500 is conceptually instantiated in a simple model 502 for a given evidence node 504, as shown in FIG. 5. Here, node B has virtual evidence node B* and C has virtual evidence node C*. In more complex models, a given evidence node can be both a parent and a child.

Virtual evidence is a category of“soft” evidence that is also referred to as likelihood evidence as it conveys the likelihood of a node's values, as opposed to the actual probability distribution of those values. For example, the virtual evidence vector [0.5, 0.25, 0.25] indicates that the first value is twice as likely as the other two but does not indicate that the probability of the first value is 0.5.

Virtual evidence corresponds to lambda messages from the virtual evidence node to the parent. Since the belief for virtual nodes are irrelevant, there is no need to send pi messages to them and no need for belief computation within them. Consequently, the virtual nodes are not implemented as actual nodes in the model. Instead the virtual nodes are implemented as special lambda messages.

Furthermore, Pearl's virtual evidence, which is not used to decay evidence, represents actual observed evidence. The evidence originates from a source external to the model but nevertheless represents observed evidence of some sort. The “decay evidence” approach uses “pseudo” virtual evidence that is derived entirely from the model itself; it does not represent actual observed evidence.

This approach creates virtual evidence nodes that send lambda messages that when combined with the other evidence “force” a belief onto the parent evidence (decaying) node. Observations are treated as before to assign a deterministic state to random variable of a node, that state being assigned a probability of one and the remaining states a probability of zero. Unlike the timer method, the observations are not held over the decay period. Following an observation, a target belief is computed by executing belief propagation on the model absent evidence of a given decay node. The virtual evidence node computes a step along a path from the current belief (initially the deterministic state) to the target belief to determine the specified belief BEL*. The virtual node uses the pi value π(x) for the decaying node x to determine the lambda message required to force the specified belief BEL* onto the parent node. The lambda message constitutes “pseudo” virtual evidence derived from the model; it is does not represent actual observed evidence. After each application of evidence, belief propagation is executed to process the lambda and pi messages to update node beliefs. The target beliefs for decaying nodes are updated and observation evidence is removed. As time progresses over the decay period, the observation and the initial deterministic state is de-emphasized relative to the target belief assigned to a node by the model absent the observation providing for a smooth, continues transition at the end of the decay period.

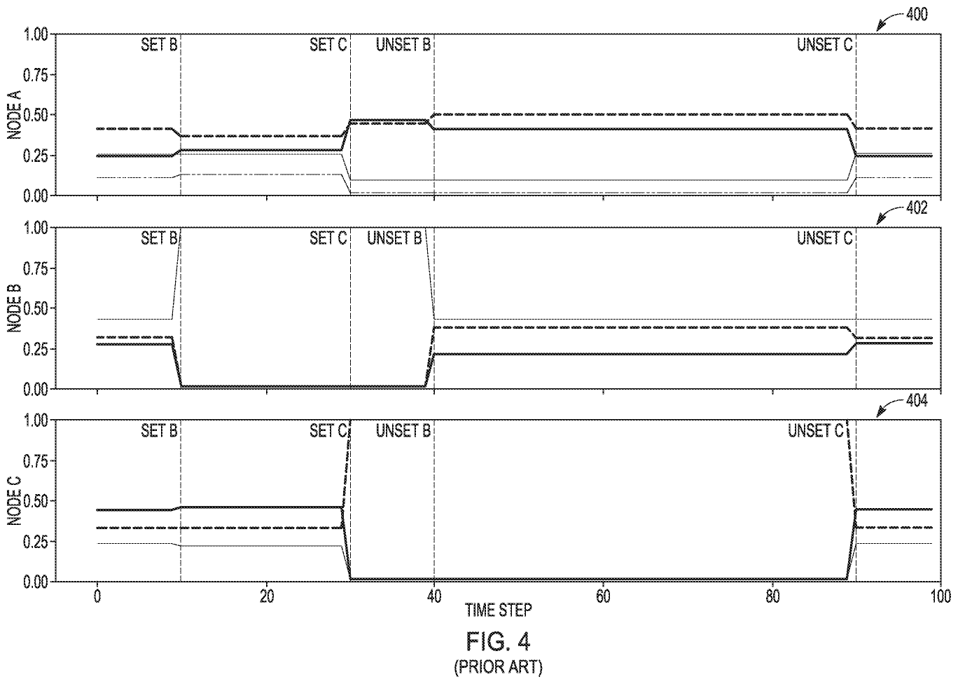

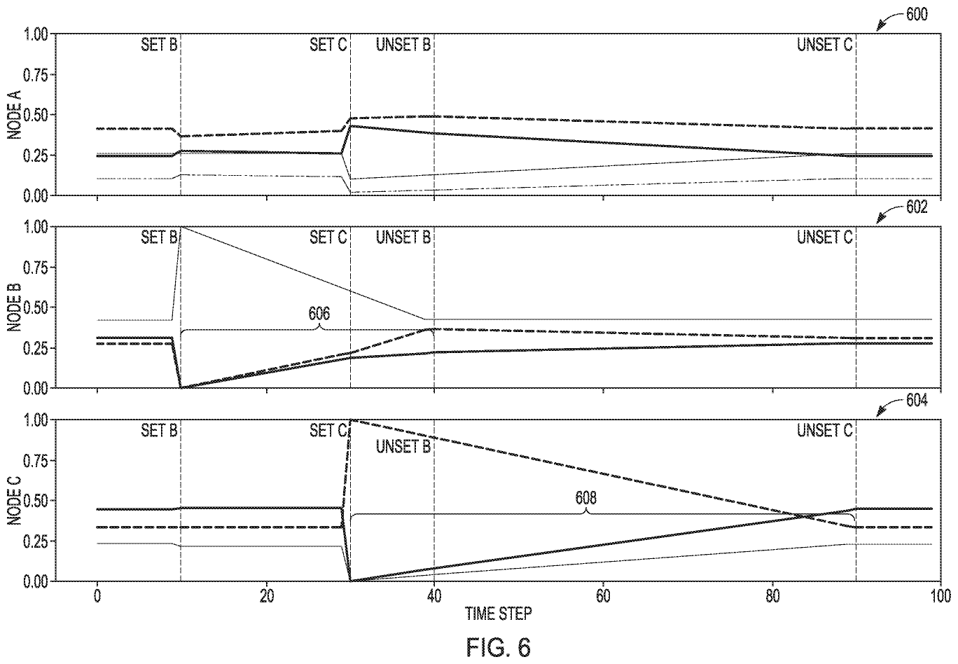

Referring now to FIG. 6, consider the same scenario illustrated in FIG. 4 for the timer method but using pseudo virtual evidence to force the node's current belief to decay in a smooth, continuous manner over the decay period to the node's target belief. If A is a 4-dimensional variable and B and C are each 3-dimensional, the resulting beliefs 600, 602 and 604 over time might look like that shown in FIG. 6. As before Node A's belief 600 exhibits discontinuous changes at time 10 and time and time 30 when the knowledge discontinuously changes with the observation of variables B and C, respectively.

However, the knowledge does not discontinuously change at times 40 and 90 at the end of the decay periods for the observations for variables B and C. During the period following the observation of an evidence random variable, confidence in the knowledge reduces monotonically, eventually becoming zero. During this knowledge “decay period”, it makes sense that the current “forced” belief should change in a smooth manner toward the belief value it has when the evidence in question is completely removed from the model. As shown, the beliefs 602 and 604 decay smoothly and continuously from the time of the observation over the decay periods 606 and 608, respectively, to the belief when all evidence is removed. As a result, belief 600 of the parent node does not exhibit discontinuous changes at the end of decay periods. Note, as the target belief for a given decaying node is computed and updated by executing belief propagation on the model absent evidence of the decaying node that target belief can and will vary based on the evidence in the rest of the model.

To achieve the “decay” of an evidence node's belief, virtual evidence is used in a non-standard way to “force” a desired belief distribution on an evidence node. This enables moving the belief associated with a given evidence variable along a trajectory in belief space that represents decreasing confidence. The evidence decay approach maintains a belief target for every decaying evidence node. The vector from the present node belief to this decay target belief represents the belief path to follow during the decay process, as discussed above. The velocity with which the specified belief moves along the trajectory is based, at least in part, on the trajectory length and the remaining decay time. The belief target for an evidence node is defined as the belief for that node given all other evidence in the model, except any evidence for the node in question. Thus, if evidence is applied to a node, it must be removed and the model updated in order to obtain the target belief.

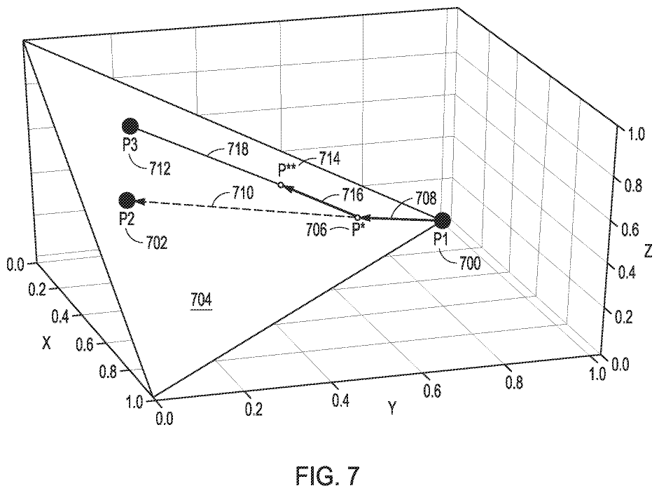

Consider a 3-dimensional evidence variable, V, with belief, BEL(V)=(x,y,z). V is observed and BEL(V) is assigned a certain value of P1=(0,1,0) 700 as shown in FIG. 7. Belief propagation is executed on the model absent the observation evidence for this node producing a resulting belief P2=(0.5 0 0.5) 702, which lies in a 2-D planar subspace 704 representing all possible values of BEL(V). P2 is saved as the updated target belief. Updating of the target beliefs may occur at the end of one step or at the beginning of the next step.

At the next update, the node belief is forced from P1 to P* 706 by a step 708 along a trajectory 710 between P1 and P2. Belief propagation is applied to the model to update beliefs and then for each decaying node is again applied to the model absent evidence of the decaying node to generate the updated target beliefs BEL*. In this example, belief propagation produces a resulting belief P3=(0.2 0.1 0.7) 712, which is saved as the target belief. At the next update, the node belief is forced from P* 706 to P** 714 by a step 716 along a trajectory 718 between P3 and P*. The process repeats at each evidence update until reaching the end of the decay period. This ensures smooth changes in the evidence node's belief and also accomplishes the goal of achieving smooth changes in target node belief during the evidence decay process.

Under BP, posterior probabilities in a probabilistic model (i.e. beliefs) are updated via a message passing algorithm [Pearl]. Belief at node X is computed as:

BEL(x)=αλ(x)π(x) (1)

Here, π(x) represents the probability of x given evidence in the model above node X (i.e. the parent's network excluding node X) and λ(x) represents the probability of the evidence below node X, given the observed value of X. The latter is given by the product of lambda messages from the children of node X:

$$λ ( x ) = {Π}_{c ∈ CH ( X )} {λ}_{c} ( x )$$

Where CH(X) is the set of nodes corresponding to X's children. The model is only concerned with controlling belief in evidence nodes, which may or may not have child nodes. A conceptual child node corresponding to a virtual evidence node, X*, sends a lambda message λ_{X*}(x). This is a conceptual node only since it is not necessary to actually instantiate the virtual evidence node in the model.

Given a specified belief to force on node x, BEL*, solve for the corresponding lambda message necessary under (1):

$$λ ( x ) = {λ}_{{X}^{*}} ( x ) = \frac{{BEL}^{*}}{π ( x )} \qquad ( 2 )$$

Here, all quantities are vectors and the division is performed element-wise. This lambda message is pseudo virtual evidence because it does not represent actual observed evidence. Instead, it represents the virtual evidence implied by the belief to be imposed. Thus, belief is forced on an evidence node by setting the node's lambda value according to (2) and executing the standard BP algorithm.

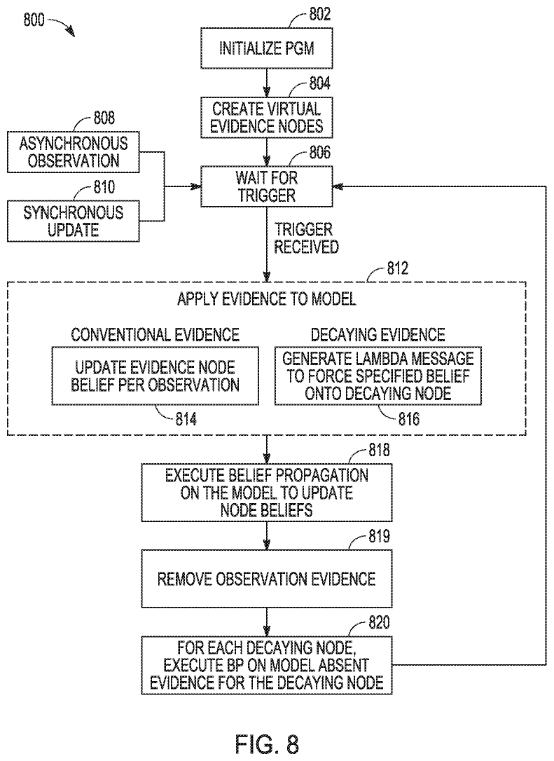

Referring now to FIG. 8, an embodiment of a method 800 of evidence decay in probabilistic trees via pseudo virtual evidence must accomplish three things. First, a belief is forced onto a decaying node by sending from the virtual evidence node a lambda message that when combined with other evidence of the decaying node will produce the specified belief. Secondly, belief propagation is executed on the model to process all of the evidence, including the lambda messages from the virtual evidence nodes, to update the beliefs for all nodes in the model every time a belief is forced onto a given node or an observation occurs. Third, the belief targets for all decaying nodes must be updated.

A PGM is a model of random variables whose conditional dependence is represented by a probabilistic tree structure including parent and child nodes that represent unobservable query and observable evidence random variables. Each node (x) has a belief vector BEL(x) of n possible values whose probabilities sum to one for a random variable. The belief vectors BEL(x) are computed by inference using belief propagation (BP) in which lambda messages representing the probability of a sub-network below the parent node given the belief of the parent node are passed upwards to the parent nodes and pi messages representing the probability of a sub-network including the parent node and above are passed downward to each child node.

The method initializes the PGM using belief propagation on the tree structure to initialize the beliefs for all nodes (step 802). The method creates virtual evidence nodes for evidence nodes that may or will be decayed (step 804). This may be done as part of the initialization process as shown or created on the fly following the observation of a random variable associated with a particular evidence node.

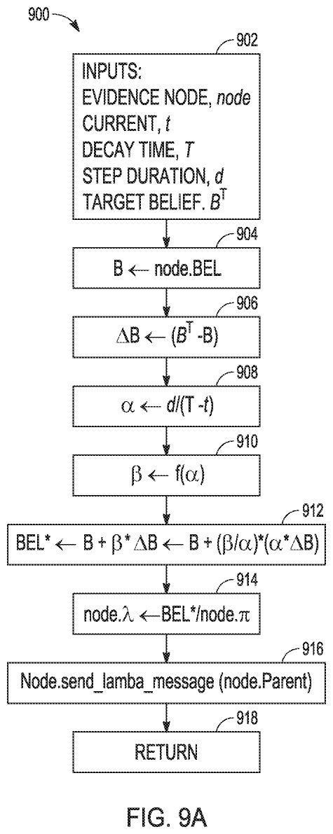

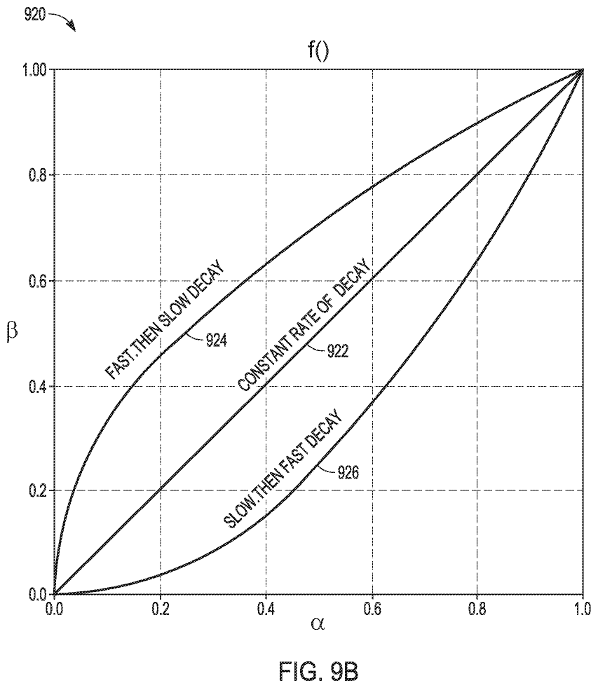

Upon occurrence of an evidence update or “trigger” (step 806), which may be the result of either an asynchronous observation of a random variable (step 808) or a synchronous update of a decaying random variable (step 810), the method applies the new evidence to the model (step 812). The method applies “conventional evidence” to the model by updating the evidence node belief based on an observation (step 814) for every evidence node with a corresponding observation. The deterministic state associated with the observation is applied once and is not held. The virtual evidence nodes apply “decaying evidence” to the model by computing a step along a path from the node's current belief to a target belief to determine a specified belief and generating a lambda message that when combined with other evidence in the model forces a specified belief onto the decaying node e.g., any evidence node within its decay period following an observation (step 816). This is done using a belief forcing algorithm shown in FIG. 9.

Once all of the evidence has been applied to the model, the method executes belief propagation on the model to process all of the evidence including the “special” lambda messages from the virtual evidence nodes to update node beliefs (step 818). Any time evidence is applied to a node, either as conventional evidence in a non-decay context, or as pseudo virtual evidence in a decay context, the belief target for all other nodes potentially changes. Thus, it is necessary to update these belief targets every time evidence is set anywhere in the mode.

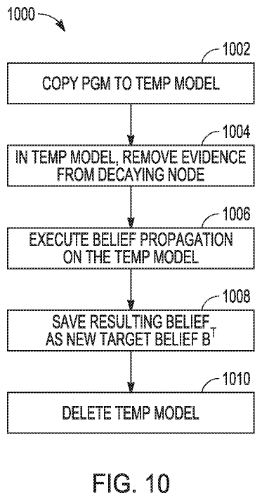

For each decaying evidence node (including those for which an observation was just made), the method removes observation evidence at the onset of the decay period (step 819) and executes belief propagation on the model without the evidence of the particular decaying evidence node to update the target belief for that node (step 820). This is done using an update target belief algorithm shown in FIG. 10. Although shown to occur at the end of a model update, the target beliefs could be updated at the beginning of the next model update prior to the application of evidence. The two are equivalent.

The model waits for the next trigger (step 806) and repeats the process, updating the joint probability distributions over all of the nodes represented by the model and the posterior probability distribution for each node. In particular, the model provides the posterior probability distribution for non-observable query nodes. These belief vectors provide the likelihood of some physical attribute or characteristic of an object. For example, the belief vector may provide the likelihood of a flower being a particular type or Iris.

This process requires more executions of the BP algorithm than is necessary under the timer method; however it allows the process to precisely decay evidence in a smooth manner. Note that every time a variable's evidence changes, either through decay or via an observation, it is necessary to update the belief target of every other variable in the model. Thus, the decay trajectories are not necessarily lines in belief space since the targets do not remain fixed.

One limitation of the approach described above is that the resulting belief in the evidence nodes is non-commutative. This is because the order in which the decay value is applied to nodes under the decay process will affect the results. This means that only the last node for which a belief was forced will have the forced value. All others will be perturbed slightly off of their forced values by the subsequent variables. This should not prevent the overall goal from being achieved, i.e. smooth changes in belief in the target variable but could be considered undesirable. The effects of this on the evidence variables could be minimized by decaying variables on small time intervals and randomizing the order in which the variables are selected during the update loop.

In an alternate embodiment, to reduce computation complexity, the method may calculate the updated target belief only once for an observed node, either the current belief just prior to the observation or an updated target belief immediately following the observation. The deterministic state (belief) associated with the observation would be stepped over the decay period to this target belief. If the model generates a target belief for the node (sans the node evidence) that is relatively stable over the decay period, the overall goal of a smooth decay and transition at the end of the decay period should be achieved. If the target belief changes considerably due to new evidence at other nodes, the decay although smooth may exhibit a degree of discontinuity at the end of the decay period.

Referring now to FIGS. 9a and 9b, the belief forcing algorithm 900 computes a specified believe BEL* as a step down a path from the current belief B to a target belief B^{T}, determines the lambda message (virtual evidence) that when combined with other evidence π(x) of the decaying node will force the specified belief onto the node (x), and sends the lambda message to the decaying node.

In an embodiment, the belief forcing algorithm receives as inputs knowledge of the current time t, decay end time T, step duration d and target belief B^{T} to force a belief onto a decaying node node (step 902). The forcing algorithm saves the current belief (node.BEL) in variable B (step 904) and computes a belief path ΔB as the difference between the target belief B^{T} and current belief B (step 906). The forcing algorithm computes a unitless measure α as the ratio of step duration d to the remaining time in the decay period (T−t) (step 908) and a unitless measure β as a function of α (step 910).

The forcing algorithm multiplies a step size (α*ΔB) with a scale factor (β/α) and adds that to the current belief B to get the specified belief BEL* (step 912). The forcing algorithm divides the specified belief BEL* by the other evidence for the parent node (pi value π(x)) to determine the lambda message (node.λ) that when combined with the other evidence will force the specified belief onto the parent node (step 914). The forcing algorithm then sends the lambda message to the parent node (step 916) and returns (step 918).

Generally speaking α and β can be computed in many different ways as long as the current belief B is stepped along the path towards the target belief B^{T}. The steps should be small enough to maintain a smooth, continuous decay and large enough to reach the target belief at the end of the decay period to avoid a discontinuity.

In this particular embodiment, the function for computing α in step 908 provides for equal length steps down the path under certain conditions. Assuming that the target belief does not change (which it will), that the number of steps n in the decay period is an integer number and that the scale factor is a constant of one, the update of BEL* in step 912 becomes BEL*=B plus ΔB (for the 1^{st} step) divided by the number of steps n of equal step duration d. For example, if n=10, α steps from 1/10, 1/9, . . . 1/2 to 1 while ΔB steps from ΔB, (9/10*ΔB), . . . . (2/10*ΔB) to (1/10*ΔB). Under actual conditions in which the target belief does change and the decay period is not an integer number of steps, the step size will vary somewhat but the goal of taking approximately equal steps throughout the decay period to de-emphasize the initial observation will be maintained.

The function β=f(α) 920 in step 910 for computing the scale factor β/α provides for the ability to control the rate of decay over the decay period. For simplicity, assume α provides for equal step sizes over the decay period. If β=α the scale factor is one throughout the decay period. The emphasis of the initial observation will decay at a constant rate 922. If f(α) is a function whereby the scale factor starts at a value >1 and is reduced as α increases with time, the emphasis of the initial observation will decay quickly at first and then slow down 924. Conversely, if f(α) is a function whereby the scale factor starts at a value <1 and is increased as α increases with time, the emphasis of the initial observation will decay slow at first and then speed 924.

These embodiments are merely illustrative of a way to step along the path from the current belief towards the target belief Alternately, one could forego the computations of α and β and simply fix the value of β in step 912 at a certain percentage e.g. 50%. In this case, the forcing algorithm would take a step of 50% of the current path ΔB. Unless the target belief is fluctuating wildly, which is unlikely, AB should be getting smaller and smaller and thus stepping halfway down the path at each update should converge to approximately the target value at the end of the decay period.

Referring now to FIG. 10, an embodiment of an update target belief algorithm 1000 computes an updated target belief for a decaying evidence node by executing belief propagation on the model absent evidence of that decaying evidence node. The algorithm copies the current instantiation of the PGM to a temporary model (step 1002) and removes evidence from the node in question from the temporary model (step 1004). The algorithm then executes belief propagation on the temporary model (step 1006) and saves the resulting node belief as the updated target belief V^{T} (step 1008) and deletes the temporary model (step 1010).

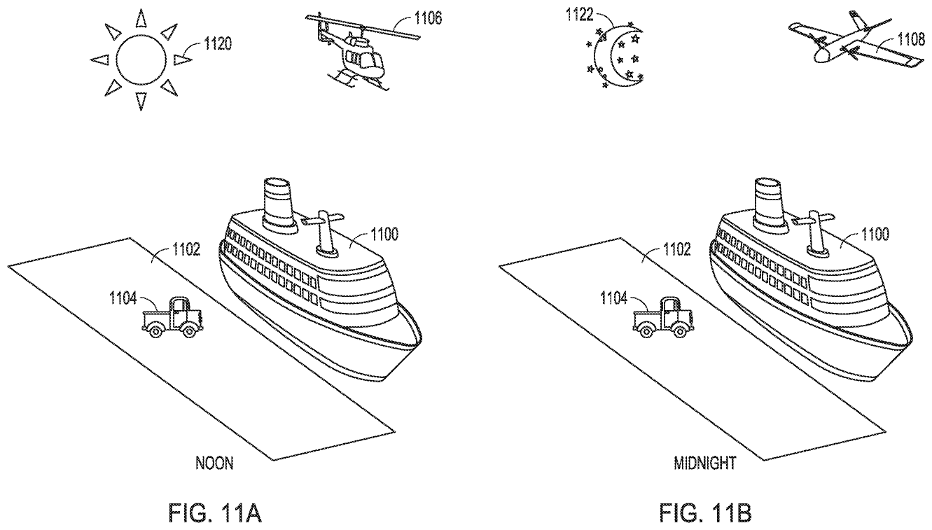

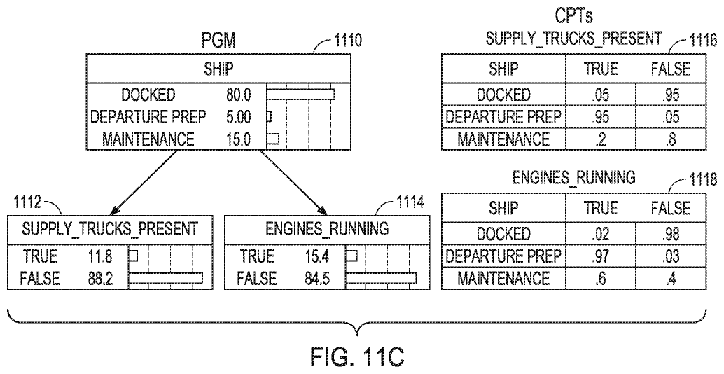

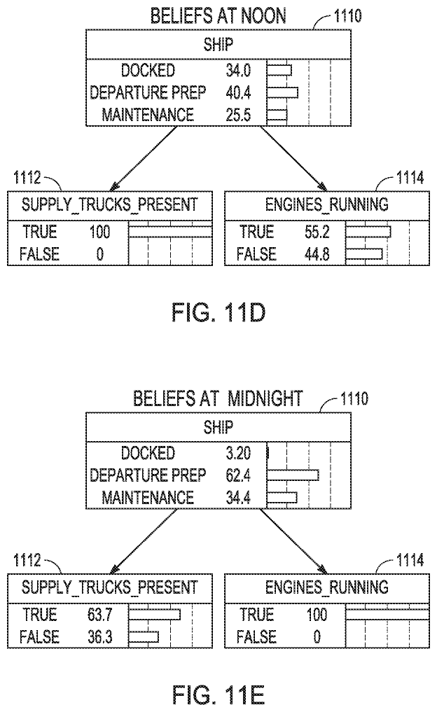

Referring now to FIGS. 11a through 11e, a PGM is used to provide a belief as to the pre-departure state of a ship at a dock 1102. Supply trucks 1104 are present to supply the ship 1100 before departure. A helicopter 1106 is outfitted with a high resolution electro-optical (EO) visible sensor. A UAV 1108 is outfitted with an EO IR sensor. The PGM has a non-observable query node 1110 for the pre-departure state of the ship including docked, departure prep and maintenance. Observable evidence nodes 1112 as to the presence of supply trucks and 1114 as to whether the ship's engines are running provide evidence to parent node 1110. CPTs 1116 and 1118 provide the conditional probabilities for evidence nodes 1112 and 1114, respectively.

At noon, with the sun 120 out the helicopter 1106 images the ship at the dock and determines that the supply trucks are present. The visible light sensor is unable to determine whether the ship's engines are running or not. As shown in FIG. 11d, the observation of the trucks updates the state of node 1112 to true 100%, which updates the beliefs of query (parent) node 1110 to increase the likelihood that the ship is either in departure prep or maintenance and not merely docked.

At midnight, with the moon 122 the UAV 1108 takes an IR image, which reveals that the ship's engines are running. The IR image cannot determine the presence of the supply trucks. Although there is an EO visible light sensor on the UAV, it is too dark to see the trucks. This means the system cannot re-observe the presence of trucks.

As shown in FIG. 11e, the observation of the engine's running updates the state of node 1114 to true 100%. The observation of the supply trucks at noon is still within the decay period. As shown, the decay evidence approach has decayed the evidence from 100% true to 63.7% true over the 12 hour period. The updated evidence in form of the observation of the engine's running and the decayed evidence of the supply trucks present updates the belief of query (parent) node 1110 to further increase the likelihood that the ship is either in departure prep or maintenance and reduce the likelihood that the ship is merely docked to a few percent.

Generally speaking the PGM is represented by a probabilistic trees structure including parent and child nodes, some of which represent unobservable (query) variables and others of which represent observable (evidence). Evidence nodes correspond to variables whose values can be directly measured. The unobservable variables represent a state for one or more objects. For example, the state may be a detection, classification, identification, or operating status of the object. The observable variables represent a physical attribute of the object that provides evidence as to the state of that object. For example, the physical attribute could size, shape, color, heat signature, RF signature or countless other physical attributes that provide evidence. The “decay evidence” approach processes the observations of the physical attributes to update beliefs for the unobservable variables for the state of the object(s).

### Example Machine Architecture and Machine-Readable Medium

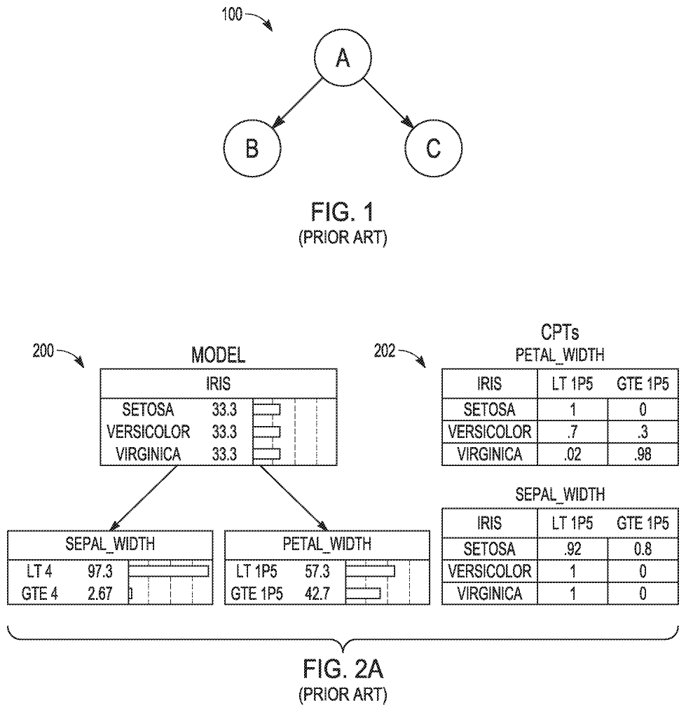

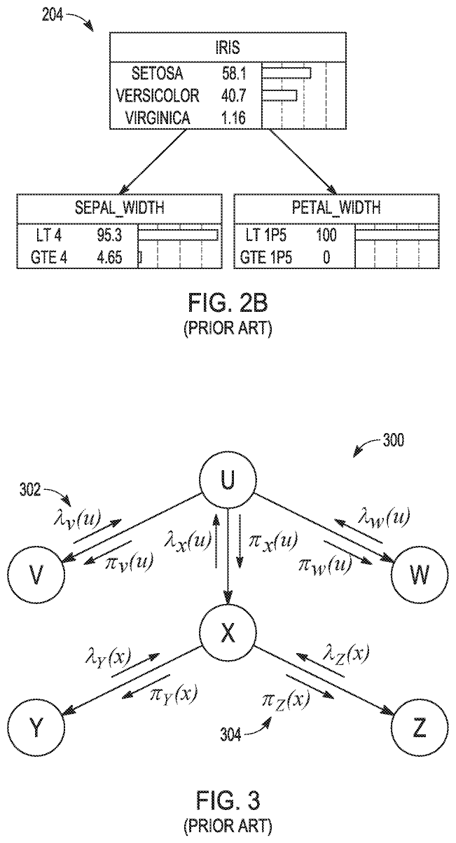

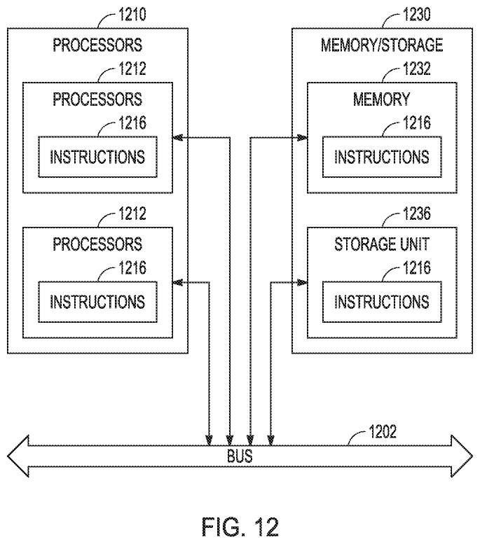

FIG. 12 is a block diagram illustrating components of a machine 1200, according to some example embodiments, able to read instructions from a machine-readable medium (e.g., a machine-readable storage medium) and perform any one or more of the methodologies discussed herein. Specifically, FIG. 12 shows a diagrammatic representation of the machine 1200 in the example form of a computer system, within which instructions 1200 (e.g., software, a program, an application, an applet, an app, or other executable code) for causing the machine 1200 to perform any one or more of the methodologies discussed herein may be executed. For example the instructions may cause the machine to execute the GPM and belief propagation of FIGS. 1-4, the addition of virtual evidence nodes in FIG. 5 and low diagrams of FIGS. 8, 9a-9b and 10. The instructions transform the general, non-programmed machine into a particular machine programmed to carry out the described and illustrated functions in the manner described. In alternative embodiments, the machine 1200 operates as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a personal computer (PC), a tablet computer, a laptop computer, a netbook, a personal digital assistant (PDA), or any machine capable of executing the instructions 1216, sequentially or otherwise, that specify actions to be taken by machine 1200. Further, while only a single machine 1200 is illustrated, the term “machine” shall also be taken to include a collection of machines 1200 that individually or jointly execute the instructions 1216 to perform any one or more of the methodologies discussed herein.

The machine 1200 may include processors 1210 and memory 1230, which may be configured to communicate with each other such as via a bus 1202. In an example embodiment, the processors 1210 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 1212 and processor 1214 that may execute instructions 1216. The term “processor” is intended to include multi-core processor that may comprise two or more independent processors (sometimes referred to as “cores”) that may execute instructions contemporaneously. Although FIG. 12 shows multiple processors, the machine 1200 may include a single processor with a single core, a single processor with multiple cores (e.g., a multi-core process), multiple processors with a single core, multiple processors with multiples cores, or any combination thereof.

The memory/storage 1230 may include a memory 1232, such as a main memory, or other memory storage, and a storage unit 1236, both accessible to the processors 1210 such as via the bus 1202. The storage unit 1236 and memory 1232 store the instructions 1216 embodying any one or more of the methodologies or functions described herein. The instructions 1216 may also reside, completely or partially, within the memory 1232, within the storage unit 1236, within at least one of the processors 1210 (e.g., within the processor's cache memory), or any suitable combination thereof, during execution thereof by the machine 1200. Accordingly, the memory 1232, the storage unit 1236, and the memory of processors 1210 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Electrically Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 1216. The term “machine-readable medium” shall also be taken to include any medium, or combination of multiple media, that is capable of storing instructions (e.g., instructions 1216) for execution by a machine (e.g., machine 1200), such that the instructions, when executed by one or more processors of the machine 1200 (e.g., processors 1210), cause the machine 1200 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

While several illustrative embodiments of the invention have been shown and described, numerous variations and alternate embodiments will occur to those skilled in the art. Such variations and alternate embodiments are contemplated, and can be made without departing from the spirit and scope of the invention as defined in the appended claims.

We claim:

1. A method of evidence decay in a probabilistic graphical model (PGM) of random variables whose conditional dependence is represented by a probabilistic tree structure including parent and child nodes that represent unobservable query and observable evidence random variables, each node having a belief vector of n possible values whose probabilities sum to one for a random variable, said belief vectors computed by inference using belief propagation (BP) in which lambda messages representing the probability of a sub-network below the parent node given the belief of the parent node are passed upwards to the parent nodes and pi messages representing the probability of a sub-network including the parent node and above are passed downward to each child node, said method comprising:
initializing the PGM by executing BP on the tree structure to assign current beliefs to each belief vector for all of the nodes;
creating virtual evidence nodes for one or more nodes representative of observable evidence variables;
upon occurrence of an evidence update, applying evidence to the model by,
updating the current belief to a deterministic state in which a single value equals 1 based on an observation of the random variable for that node; and
for any node within a decay period after an observation, said virtual evidence node
computing a step along a path from the node's current belief to a target belief at the end of the decay period to determine a specified belief, and
generating a lambda message that when combined with other evidence in the model forces a specified belief onto the node;
executing BP on the tree structure to process the pi and lambda messages to update the current beliefs; and
for each node within the decay period, executing BP on the tree structure absent the evidence of that node and saving the resulting belief as an updated target belief.

2. The method of claim 1, further comprising:
removing evidence of the observation from the node at the onset of the decay period.

3. The method of claim 1, wherein different observable evidence random variables have different decay periods.

4. The method of claim 1, wherein the occurrence of an evidence update comprises an asynchronous observation of an observable evidence random variable or a synchronous update of an observable evidence random variable within the decay period.

5. The method of claim 1, wherein computing the step along the path computes steps of approximately equal length along the path for each unit of time over the decay period.

6. The method of claim 5, further comprising weighting the steps of approximately equal length by a time-variant scale factor.

7. The method of claim 1, wherein computing the step along the path computes steps that are relatively longer at the onset of the decay period and relatively shorter at the end of the decay period.

8. The method of claim 1, wherein computing the step along the path computes steps that are relatively shorter at the onset of the decay period and relatively longer at the end of the decay period.

9. The method of claim 1, wherein computing the step along the path computes a fixed percentage of the path at each step.

10. The method of claim 1, wherein computing the step along the path computes β*ΔB where ΔB=B^{T}−B where B^{T} is the target belief and B is the current belief and β=f(α) where α=d(T−t) where d is the step duration, T is decay period end time and t is the current time.

11. The method of claim 1, wherein the step of generating the lambda message comprises dividing the specified belief by a pi value for the node.

12. The method of claim 1, wherein the updated belief target for a node is computed by
copying the PGM to a temporary model;
removing the evidence from that node from the temporary model;
executing belief propagation the temporary model to generate a belief for the node;
saving the belief as the updated target belief; and
deleting the temporary mode.

13. The method of claim 1, wherein at least one said unobservable query random variable represents a physical state of one or more objects, wherein a plurality of said observable evidence random variables represent physical attributes of the one or more objects that provide evidence as to the physical state of the one or more objects, further comprising using sensors to make observations of the observable evidence random variables whereby the method processes and decays the observation to update beliefs for the at least one said unobservable query random variable and the physical state of the one or more objects.

14. The method of claim 13, wherein the computation of the beliefs for the at least one said unobservable query random variable supports intelligence, surveillance or reconnaissance operations of the one or more objects.

15. An apparatus comprising:
at least one processor configured to:
implement a probabilistic graphical model (PGM) of random variables whose conditional dependence is represented by a probabilistic tree structure including parent and child nodes that represent unobservable query and observable evidence random variables, each node having a belief vector of n possible values whose probabilities sum to one for a random variable, said belief vectors computed by inference using belief propagation (BP) in which lambda messages representing the probability of a sub-network below the parent node given the belief of the parent node are passed upwards to the parent nodes and pi messages representing the probability of a sub-network including the parent node and above are passed downward to each child node, said method comprising:
initialize the PGM by executing BP on the tree structure to assign current beliefs to each belief vector for all of the nodes;
create virtual evidence nodes for one or more nodes representative of observable evidence variables;
upon occurrence of an evidence update, applying evidence to the model by,
update the current belief to a deterministic state in which a single value equals 1 based on an observation of the random variable for that node; and
for any node within a decay period after an observation, said virtual evidence node
compute a step along a path from the node's current belief to a target belief at the end of the decay period to determine a specified belief, and
generate a lambda message that when combined with other evidence in the model forces a specified belief onto the node;
execute BP on the tree structure to process the pi and lambda messages to update the current beliefs; and
for each node within the decay period, execute BP on the tree structure absent the evidence of that node and saving the resulting belief as an updated target belief.

16. The apparatus of claim 15, wherein said at least one processor is configured to,
remove evidence of the observation from the node at the onset of the decay period.

17. The apparatus of claim 15, wherein to generate the lambda message said at least one processor is configured to divide the specified belief by a pi value for the node.

18. The apparatus of claim 15, wherein at least one said unobservable query random variable represents a physical state of one or more objects, wherein a plurality of said observable evidence random variables represent physical attributes of the one or more objects that provide evidence as to the physical state of the one or more objects, said apparatus further comprising:
at least one sensor configured to make observations of the observable evidence random variables, wherein said at least one processor processes and decays the observation to update beliefs for the at least one said unobservable query random variable and the physical state of the one or more objects.

19. A non-transitory machine-readable medium including instructions which, when executed by at least one processor, cause the at least one processor to:
implement a probabilistic graphical model (PGM) of random variables whose conditional dependence is represented by a probabilistic tree structure including parent and child nodes that represent unobservable query and observable evidence random variables, each node having a belief vector of n possible values whose probabilities sum to one for a random variable, said belief vectors computed by inference using belief propagation (BP) in which lambda messages representing the probability of a sub-network below the parent node given the belief of the parent node are passed upwards to the parent nodes and pi messages representing the probability of a sub-network including the parent node and above are passed downward to each child node, said method comprising:
initialize the PGM by executing BP on the tree structure to assign current beliefs to each belief vector for all of the nodes;
create virtual evidence nodes for one or more nodes representative of observable evidence variables;
upon occurrence of an evidence update, applying evidence to the model by,
update the current belief to a deterministic state in which a single value equals 1 based on an observation of the random variable for that node; and
for any node within a decay period after an observation, said virtual evidence node
remove evidence of the observation from the node at the onset of the decay period,
compute a step along a path from the node's current belief to a target belief at the end of the decay period to determine a specified belief, and
generate a lambda message that when combined with other evidence in the model forces a specified belief onto the node;
execute BP on the tree structure to process the pi and lambda messages to update the current beliefs; and
for each node within the decay period, execute BP on the tree structure absent the evidence of that node and saving the resulting belief as an updated target belief.

20. The non-transitory machine-readable medium of claim 19, wherein at least one said unobservable query random variable represents a physical state of one or more objects, wherein a plurality of said observable evidence random variables represent physical attributes of the one or more objects that provide evidence as to the physical state of the one or more objects, said medium including instructions which, when executed by at least one processor, cause the at least one processor to:
receive observations of the observable evidence random variables from at least one sensor, process and decays the observation to update beliefs for the at least one said unobservable query random variable and the physical state of the one or more objects.
